(19) United States
(12) Patent Application Publication
(10) Pub. No.: US 2022/0138724 A1
(43) Pub. Date: May 5, 2022

(54) INFORMATION PROCESSING APPARATUS, INFORMATION PROCESSING SYSTEM, INFORMATION PROCESSING METHOD, AND PROGRAM

(71) Applicant: FeliCa Networks, Inc., Tokyo (JP)

(72) Inventor: Satoshi YUI, Kanagawa (JP)

(73) Assignee: FeliCa Networks, Inc., Tokyo (JP)

(21) Appl. No.: 17/431,607

(22) PCT Filed: Feb. 20, 2020
(86) PCT No.: PCT/JP2020/006940

§ 371 Date: Aug. 17, 2021

(30) Foreign Application Priority Data
Mar. 25, 2019 (JP) 2019-056206

(51) Int. Cl. G06Q 20/32; G06Q 20/08

(52) U.S. Cl. CPC G06Q 20/3276; G06Q 20/085

(57) ABSTRACT

A configuration allowing use of one representative card as various types of cards is achieved. There are provided a memory that stores a representative card ID that is an identifier of a representative card, and a control unit that executes a use process for using a registration card registered is association with the representative card through communication with a reader/writer. The use process for using the registration card is executed under a condition that registration card information associated with the registration card is recorded is a database in association with the representative card. The database is a database managed by a server, and including data where the representative card ID, a user ID, and an ID of the registration card registered in association with the representative card are recorded in association with each other.

### TECHNICAL FIELD

The present disclosure relates to an information processing apparatus, an information processing system, an information processing method, and a program. More specifically, the present disclosure relates to an information processing apparatus, an information processing system, an information processing method, and a program capable of, in IC cards having a payment process function, code information recording cards such as magnetic cards, barcodes, and QR codes (registered trademark), or an information processing apparatus such as a smartphone that stores applications having functions of these cards, combining a plurality of different cards into a single card, a single application, or the like, and allowing use of the single card, the single application, or the like.

### BACKGROUND ART

Use of an IC card which has an electronic money function such as a payment function, a charge function, and a credit card function, and a portable device which has an IC card function, such as a smartphone, has been increasing in recent years.

Use of an IC card or a portable device (information processing apparatus) having an IC card function allows payment of shopping, eating and drinking, and the like, or of boarding on a train or a bus in an easy manner without the necessity of carrying cash.

An IC card or a device having an IC card function achieves authentication, payment processing, or the like through proximity communication established between the IC card or the device and a reader/writer (R/W) by bringing the IC card or the device close to the reader/writer (R/W).

Recently, various shops such as shopping centers, department stores, supermarkets, restaurants, and electronics retail stores issue original cards. Accordingly, the number of cards owned by a user, or the number of card applications installed in a smartphone or [0005]

For example, PTI, 1 (WO 2010/116652) is a conventional technology disclosed as a solution to this increase is the number of available applications.

PTL 1 mentioned herein discloses a configuration which selects an optimum application suited for a situation of a user from a large number of applications, and notifies the user of the selected application.

Moreover, PTL 2 (JP 2015-032149A) discloses a configuration which selects information presented to a user on the basis of location information and behavior information associated with the user.

However, none of these documents discloses a specific example of a configuration or a payment process for combining a plurality of different cards into a single card or a single application and allowing use of the single card or the single application.

### CITATION LIST

### Patent Literature

[PTL 1]

WO 2010/116652

[PTL 2]

JP 2015-032149A

### SUMMARY

### Technical Problem

The present disclosure has been developed in consideration of the aforementioned problems, for example. An object of the present disclosure is to provide an information processing apparatus, an information processing system, as information processing method, and a program capable of combining a plurality of different cards into a single card, a single application, or the like, and allowing use of the single card, the single application, or the like.

### Solution to Problem

A first aspect of the present disclosure is directed to as information processing apparatus including a memory that stores a representative card ID that is an identifier of a representative card, and a control unit that executes a use process for using a registration card registered is association with the representative card, in which the use process for using the registration card is executed under a condition that registration card information associated with the registration card is recorded in a database in association with the representative card.

In addition, a second aspect of the present disclosure is directed to an information processing system including a user device, a server, and a shop side device, in which the user device causes the shop side device to read a representative card ID stored in a memory of the user device, the shop side device transmits the representative card ID to the server, and the server determines card availability of whether or not the representative card ID is a representative card ID available for the shop side device, and executes a payment process under a condition that the card availability has been determined.

Moreover, a third aspect of the present disclosure is directed to an information processing method executed by an information processing apparatus, in which the information processing apparatus includes a memory that stores a representative card ID that is an identifier of a representative card, and a control unit of the information processing apparatus executes a use process for using a registration card registered in association with the representative card under a condition that registration card information associated with the registration card is recorded in a database in association with the representative card.

Furthermore, a fourth aspect of the present disclosure is directed to an information processing method executed by an information processing system that includes a user device, a server, and a shop side device, in which the user device causes the shop side device to read a representative card ID stored in a memory of the user device, the shop side device transmits the representative card ID to the server, and the server determines card availability of whether or not the representative card ID is a representative card ID available for the shop side device, and executes a payment process under a condition that the card availability has been determined.

In addition, a fifth aspect of the present disclosure is directed to a program causing an information processing apparatus to execute information processing, in which the information processing apparatus includes a memory that stores a representative card ID that is an identifier of a representative card, and the program causes a control unit of the information processing apparatus to execute a use process for using a registration card registered is association with the representative card under a condition that registration card information associated with the registration card is recorded in a database in association with the representative card.

Note that the program of the present disclosure is a program providable by a storage medium or a communication medium in a computer-readable form for an information processing apparatus or a computer system capable of executing various types of program codes, for example. By providing this program in the computer-readable form, processes corresponding to the program is achievable using the information processing apparatus or the computer system.

Further objects, features, and advantages of the present disclosure will become obvious in the light of more detailed description based on embodiments of the present disclosure described below, and the accompanying drawings. Note that the system in the present specification refers to a logical set configuration constituted by a plurality of devices, and is not limited to a type where devices of respective configurations are included in an identical housing.

According to an embodiment of the present disclosure, a configuration allowing use of one representative card as various types of cards is achievable.

Note that advantageous effects to be produced are not limited to those described in the present specification presented only by way of example, and additional advantageous effects may be further offered.

### BRIEF DESCRIPTION OF DRAWINGS

FIG. 1 is a diagram explaining as example of an IC card owned by a user.

FIG. 2 is a diagram explaining an example of a card application is a smartphone owned by the user.

FIG. 3 is a diagram explaining an outline of a configuration of the present disclosure for allowing use of one representative card or one representative card application as a plurality of cards.

FIG. 4 is a diagram explaining a configuration example of an information processing system of the present disclosure.

FIG. 5 is a diagram explaining a specific example of a management process executed by a representative card management server.

FIG. 6 is a diagram explaining a data configuration example of a representative card management DB (database) managed by the representative card management server.

FIG. 7 is a diagram explaining an acquisition process sequence for acquiring the representative card or the representative card application.

FIG. 8 is a diagram explaining an acquisition process sequence for acquiring the representative card or the representative card application.

FIG. 9 is a sequence diagram explaining a registration process sequence for registering available actual card information for the representative card or the representative card application acquired by the user.

FIG. 10 is a diagram explaining a data configuration example of a member shop card management DB managed by a service provider.

FIG. 11 is a diagram explaining a service provider (SP) correspondence associating DB.

FIG. 12 is a diagram explaining an example of data registered in a memory of the representative card, or a memory supporting the representative card application (a memory in the smartphone).

FIG. 13 is a sequence diagram explaining a use process sequence for using the representative card or the representative card application.

FIG. 14 is a sequence diagram explaining a registration process sequence for registering available actual card information for the representative card or the representative card application acquired by the user.

FIG. 15 is a diagram explaining a stored data example of the service provider (SP) correspondence associating DB.

FIG. 16 is a sequence diagram explaining a use process sequence for using the representative card or the representative card application.

FIG. 17 is a diagram explaining an embodiment which uses code information as the representative card.

FIG. 18 is a diagram explaining an embodiment which sets use priority in a shop.

FIG. 19 is a diagram explaining an embodiment which presents information associated with an available card on the basis of user behavior history information.

FIG. 20 is a diagram depicting a system configuration example of the embodiment which presents the information associated with the available card on the basis of the user behavior history information.

FIG. 21 is a diagram explaining a process sequence of the embodiment which presents the information associated with the available card on the basis of the user behavior history information.

FIG. 22 is a diagram explaining a process sequence of the embodiment which presents the information associated with the available card on the basis of the user behavior history information.

FIG. 23 is a diagram explaining a configuration example of an IC card which is an information processing apparatus.

FIG. 24 is a diagram explaining a configuration example of a smartphone which is an information processing apparatus.

FIG. 25 is a diagram explaining a configuration example of as information processing apparatus such as a server.

### DESCRIPTION OF EMBODIMENTS

Details of an information processing apparatus, an information processing system, as information processing method, and a program of the present disclosure will be hereinafter described with reference to the drawings. Note that following items will be presented in the description.

1. Regarding Outline of Configuration of Present Disclosure

2. Regarding Configuration Example of Information Processing System of Present Disclosure

3. Regarding Acquisition Process for Acquiring Representative Card or Representative Card Application

4. Regarding Registration Process and Use Process for Registering and Using Available Actual Card Information for Representative Card

5. Regarding Embodiment Determining Card Availability by Representative Card Management Server

6. Regarding Other Embodiments

7. Regarding Available Service Presentation Process Configuration Based on User Behavior History

8. Regarding Hardware Configuration Example of Information Processing Apparatus

9. Summary of Configuration of Present Disclosure

### [1. Regarding Outline of Configuration of Present Disclosure]

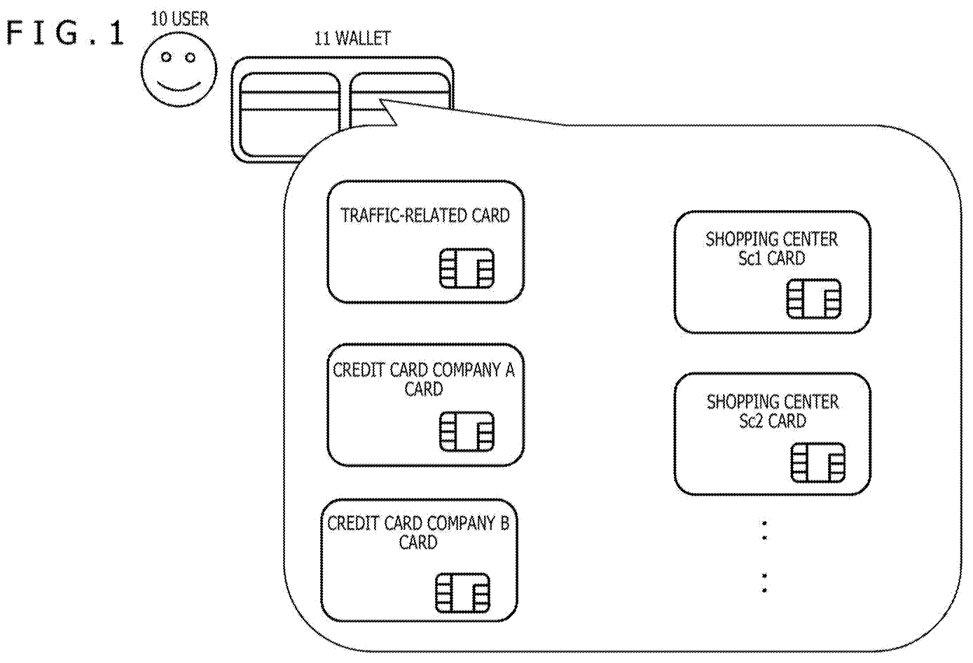

An outline of a configuration of the present disclosure will be initially described with reference to FIG. 1 and following figures.

As described above, various shops such as shopping centers, department stores, supermarkets, restaurants, and electronics retail stores issue original cards in recent years. Accordingly, the number of cards owned by a user, or the number of card applications installed in a smartphone or the like has been increasing.

Specifically, as depicted in FIG. 1, a user 10 has many IC cards inside a wallet 11, for example.

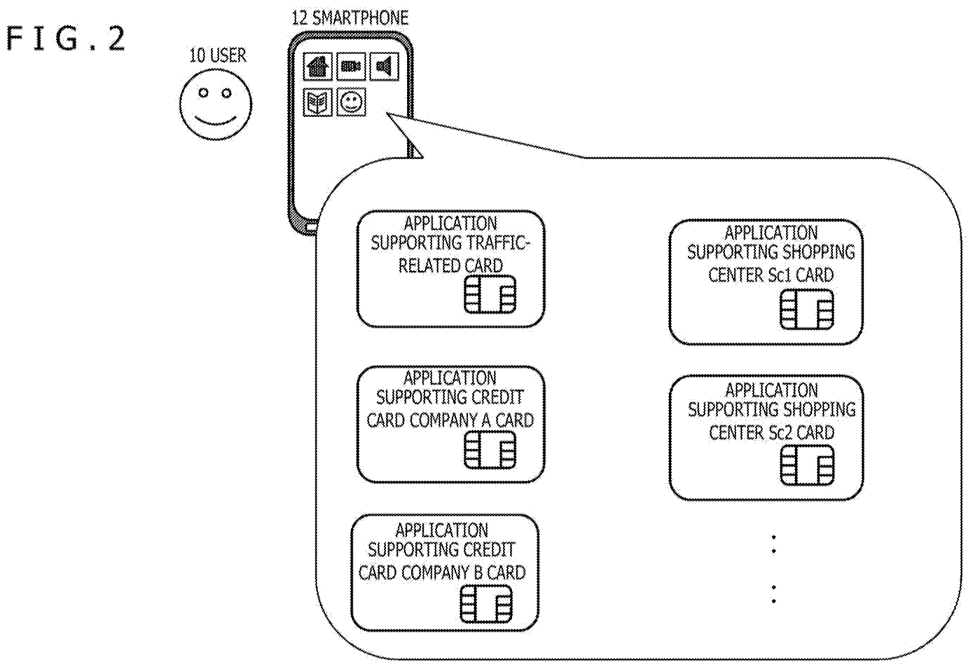

Moreover, as depicted in FIG. 2, the user 10 who uses a portable device such as a smartphone has many card function providing applications (apps) installed in a smartphone 12.

While a use example of an IC card will be chiefly described in a following embodiment, a process according to the present disclosure is applicable to a code information recording card such as a magnetic card, a barcode, and a QR code (registered trademark) in addition to the IC card, and an information processing apparatus which stores an application (app) having card functions of these cards, such as a smartphone.

The user 10 having a large number of cards or applications as described above is required to select a card or an application to be used for each shop. In this case, a burden imposed on the user increases. The present disclosure is configured to solve this problem.

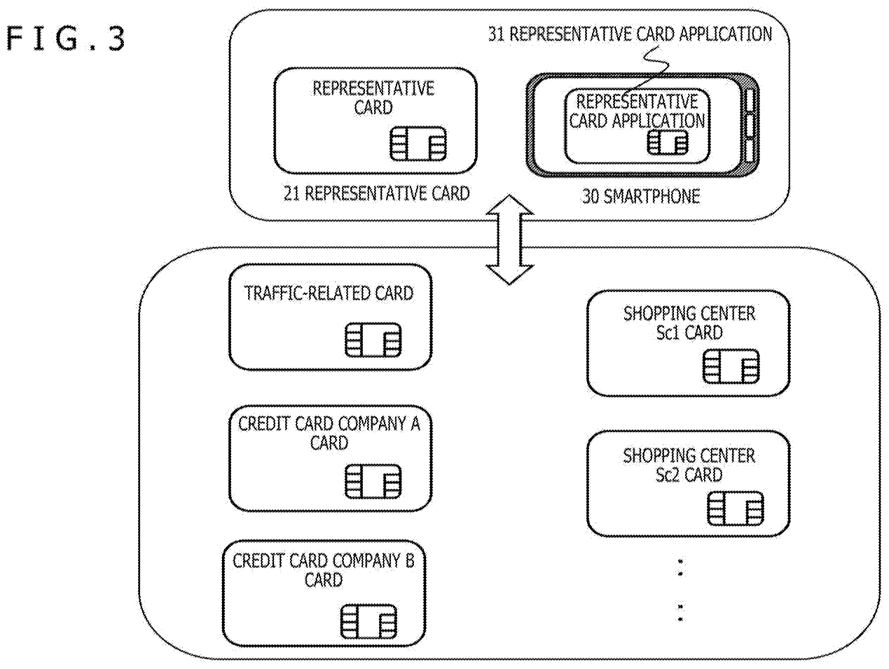

As depicted in FIG. 3, the present disclosure is configured to use one representative card 21, or one representative card application 31 installed in a smartphone 30 as various different types of cards or card applications.

### [2. Regarding Configuration Example of Information Processing System of Present Disclosure]

A configuration example of an information processing system of the present disclosure will be subsequently described.

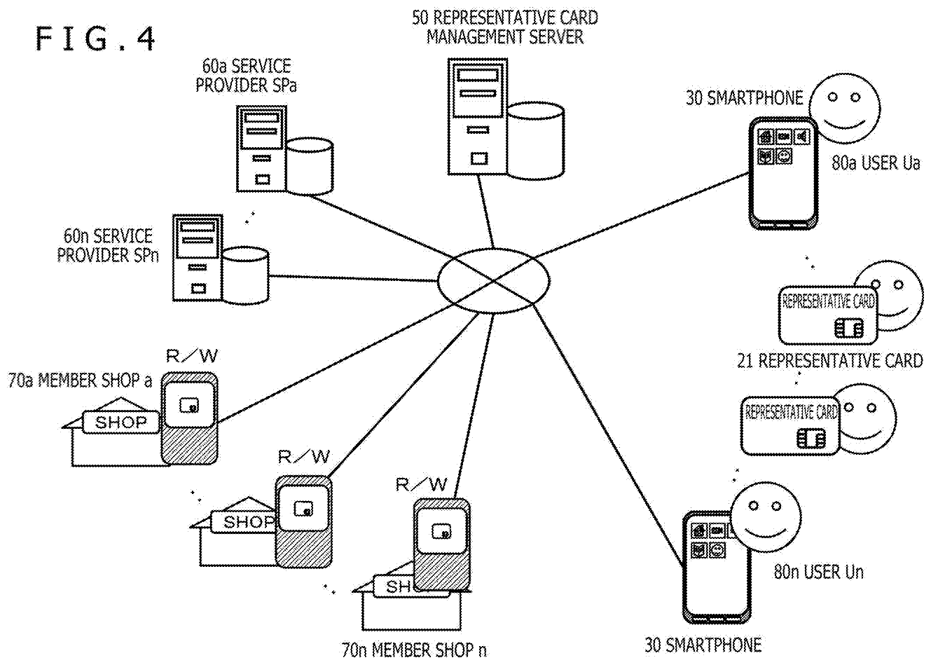

FIG. 4 is a diagram depicting a configuration example of the information processing system of the present disclosure.

A representative card management server 50 manages the representative card 21 used by a user 60, and the representative card application 3i in the smartphone 30 used by the user 80.

Each of service providers SPa to SPn, 60a to 60n is a service provider which provides a management service for managing cards available in various shops.

For example, one service provider SPx provides a management service for managing one or a plurality of credit cards, debit cards, or the like.

Each of member shops a to n, 70a to 70n is a shop where cards or card applications are available. Each of the member shops has a reader/writer (R/W) to achieve a payment process through proximity communication with the representative card 21 or the smartphone 30 owned by the user 80. Note that communication with the service providers SPa to SPn, 60a to 60n, the representative card management server 50, or the like is established at the time of the payment process.

A specific sequence of this payment process will be described in a following stage.

Note that the process of the present disclosure is also applicable to a configuration performing a process for reading a barcode or a QR code (registered trademark) displayed on the card or the smartphone owned by the user 80. In this case, each of the member shops has a device (code reader) for reading code information, and executes a process based on read information.

Described as a typical processing example in the following embodiment will be a configuration example which establishes proximity communication between the reader/writer (RIND and the representative card 21 or the smartphone 30 owned by the user 80.

Each of users Ua to Un, 80a to 80n has the representative card 21, or the representative card application 31 in the smartphone 30. The payment process is achievable through proximity communication by bringing the representative card 21 or the representative card application 31 close to the reader/writer (R/W) provided in each. of the member shops 70.

### [3. Regarding Acquisition Process for Acquiring Representative Card or Representative Card Application]

An acquisition process for acquiring the representative card or the representative card application will be subsequently described.

The user 80 can acquire the representative card or the representative card application from the representative card management server 50.

As described above, the representative card management server 50 manages the representative card 21 and the representative card application 31 in the smartphone 30 which are used by the user 80.

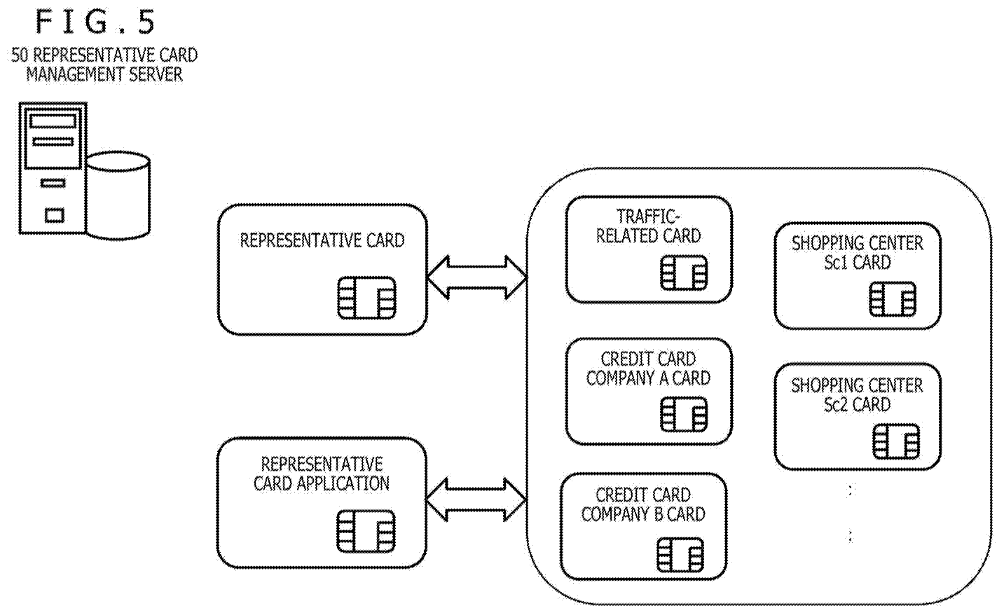

A specific example of a management process executed by the representative card management server 50 will be described with reference to FIG. 5 and following figures.

FIG. 5 is a diagram explaining an outline of the management process executed by the representative card management server 50.

The representative card management server 50 stores, in a DB, data of actual cards associated with a representative card, or a representative card application owned by each of the users, and retains and manages the data.

Specifically, the representative card management server 50 retains, in a representative, card management DB (database) 51, data corresponding to available actual cards or card applications by using the representative card or the representative card application owned by each of the users, and manages the data.

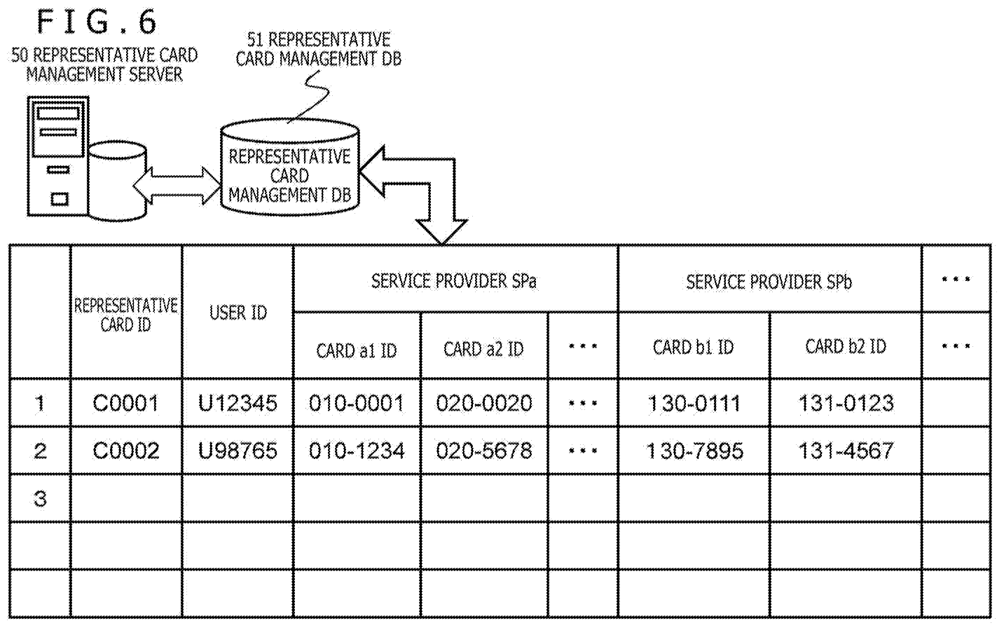

FIG. 6 depicts a data configuration example of the representative card management DB (database) 51 managed by the representative card management server 50.

As depicted in FIG. 6, following respective items of data are associated with each other and recorded in the representative card management DB (database) 51.

(1) representative card ID

(2) user ID

(3) ID of actual card associated with representative card

Note that the “(3) ID of actual card associated with representative card” is registered as a card ID uniquely given to each service provider as depicted in the figure.

For example, a card a1 ID, a card a2 ID, and others are card IDs managed by the service provider SPa.

A card b1 ID, a card b2 ID, and others are card IDs managed by the service provider SPb.

An entry 1 of the representative card management DB (database) 51 depicted in the figure is an entry indicating:

a user ID=U12345; and

a representative card (ID=C0001) owned by this user. In addition, this representative card (ID=C0001) is a card where:

the card a1 ID, the card a2 ID, and others managed by the service provider SPa; and

the card b1 ID, the card b2 ID, and others managed by the service provider SPb

are registered in association with each other.

Accordingly, a user of a user ID=U12345 can use the representative card (ID=C0001) owned by this user as the card a1 ID, the card a2 ID, and others managed by the service provider SPa, or as the card b1 ID, the card b2 ID, and others managed by the service provider SPb.

For using the representative card described above, it is necessary to initially acquire the representative card or the representative card application from the representative card management server 50.

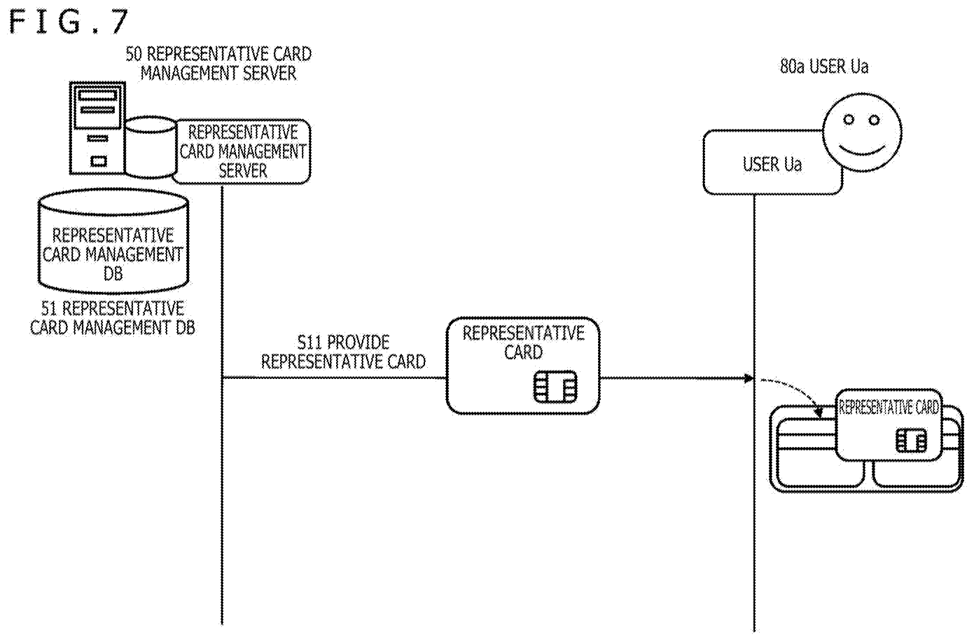

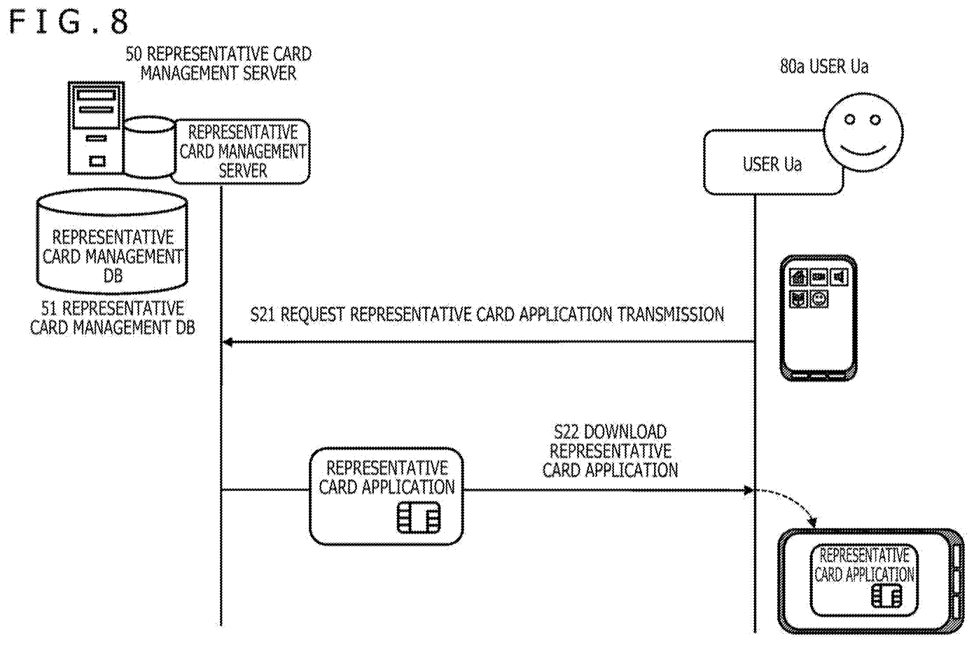

An acquisition process sequence for acquiring the representative card or the representative card application will be described with reference to FIGS. 7 and 8.

FIG. 7 is a diagram depicting a process sequence performed in a case where the user a, 80a acquires the representative card from the representative card management server 50.

Processing performed in respective steps will be sequentially described.

### (Step S11)

In step S11, the representative card management server 50 provides the representative card for the user Ua, 80a.

Note that an actual card providing process may be configured to stock empty cards as representative cards at various shops, and provides these cards for users via the shops.

Note that the representative card to be provided may be either a card where a plurality of pieces of available actual card information has been registered beforehand, or a card (empty card) where no available actual card information is registered.

The user is allowed to register available actual card information any time in the received representative card.

This process sequence will be described in a following stage.

FIG. 8 is a diagram depicting a process sequence performed in a case where the user Ua, 80a acquires the representative card application from the representative card management server 50.

Processing performed in respective steps will be sequentially described.

### (Step S21)

In step S21, the user Ua, 80a accesses the representative card management server 50 using the smartphone, and executes a representative card application transmission request.

### (Step S22)

Moreover, in step S22, the user Ua, 80a downloads the representative card application from the representative card management server 50, and installs the representative card application in the smartphone.

Note that the representative card to be downloaded also in this case may be either a card application where a plurality of pieces of available actual card information has been registered beforehand, or a card application where no available actual card information is registered.

The user is allowed to register available actual card information any time in the received representative card application.

### [4. Regarding Registration Process and Use Process for Registering and Using Available Actual Card Information for Representative Card]

Subsequently described will be a registration process and a use process for registering and using available actual card information for the representative card.

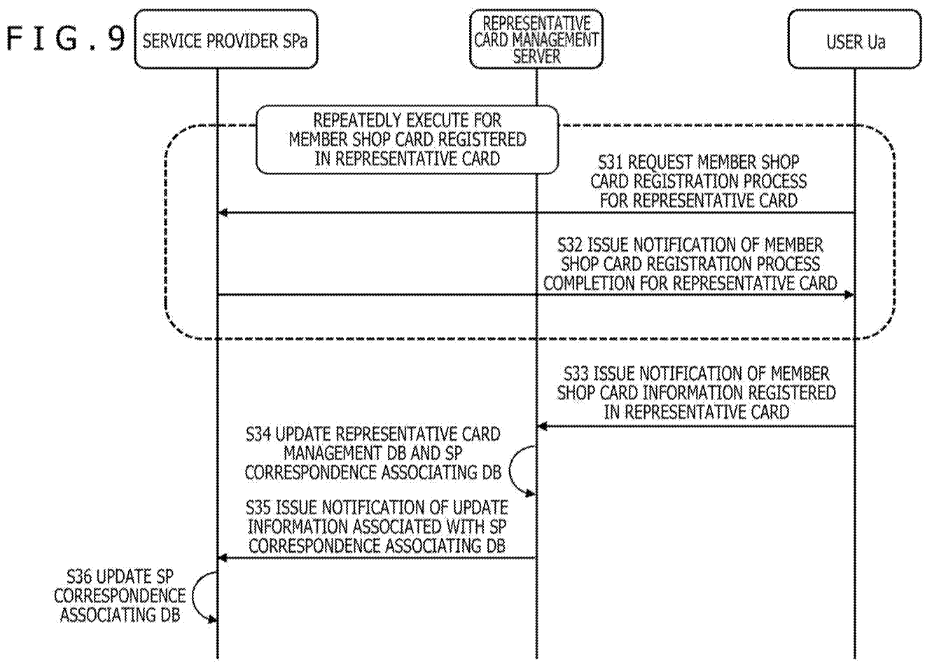

FIG. 9 is a sequence diagram explaining a registration process sequence for registering available actual card information for the representative card or the representative card application acquired by the user.

FIG. 9 depicts the service provider SPa, 60a, the representative card management server 50, and the user Ua, 80a, in this order from the left.

Processing performed in respective steps will be sequentially described.

### (Steps S31 to S32)

In step S31, the user Ua, 80a having acquired the representative card or the representative card application according to the process sequence depicted in FIG. 7 or 8 initially issues a member shop card registration request to the service provider SPa, 60a for requesting member shop card registration in the representative card or the representative card application owned by the user Ua, 80a.

In step S32, the service provider SPa, 60a having received the registration request from the user Ua, 80a configures such a setting as to make the representative card or the representative card application owned by the user Ua, 80a available as an actual member shop card, i.e., executes a member shop card registration process. Thereafter, the service provider SPa, 60a notifies the smartphone or the like of the user Ua, 80a of registration completion.

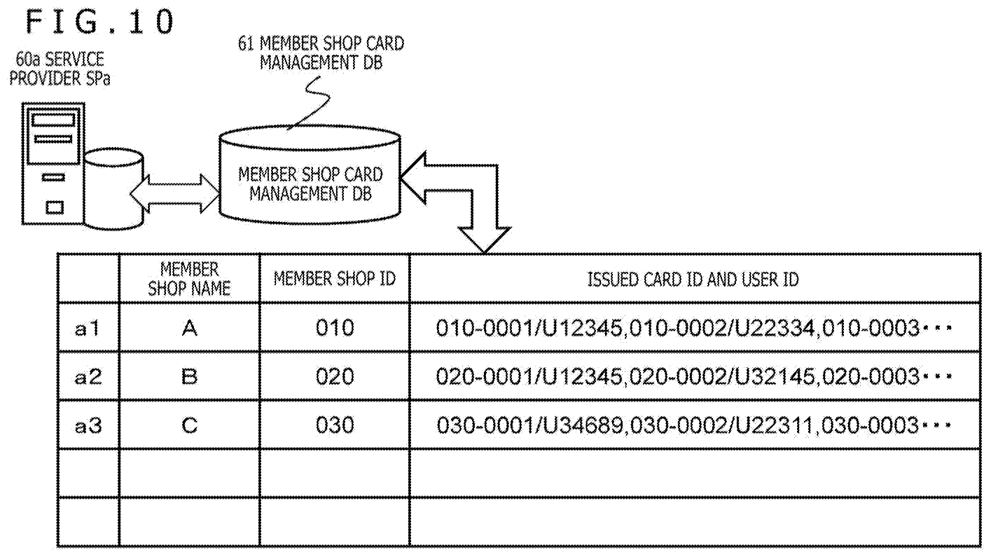

For example, the service provider SPa, 60a has a member shop card management DB 61 having a data configuration depicted in FIG. 10.

As depicted in FIG. 10, the member shop card management DB 61 is a database which stores respective data of a member shop name, a member shop ID, and an issued card ID and a user ID in association with each other.

The service provider SPa, 60a performs a process for adding one entry of “issued card ID and user ID” to entries corresponding to the member shop to which the registration request has been issued from the user Ua, 80a, and then registering the added entry in the member shop card management DB 61.

Note that the service provider SPa, 60a further executes DB update of a database which associates a representative card ID and a card ID of a card managed by the service provider (SP correspondence associating DB) in a later step. This process will be described below.

Processing in steps S31 to S32 may be executed any time and at a variety of timings for a member shop card desired to be registered in the representative card or the representative card application owned by the user Ua, 80a.

Moreover, after execution of processing in steps S31 to S32, a DB update process for updating the SP correspondence associating DB is executed in step S33 and following steps.

### (Step S33)

In step S33, the user Ua, 80a having received the registration completion notification from the service provider SPa, 60a in step S32 notifies the representative card management server 50 of member shop card information registered in the representative card or the representative card application.

### (Step S34)

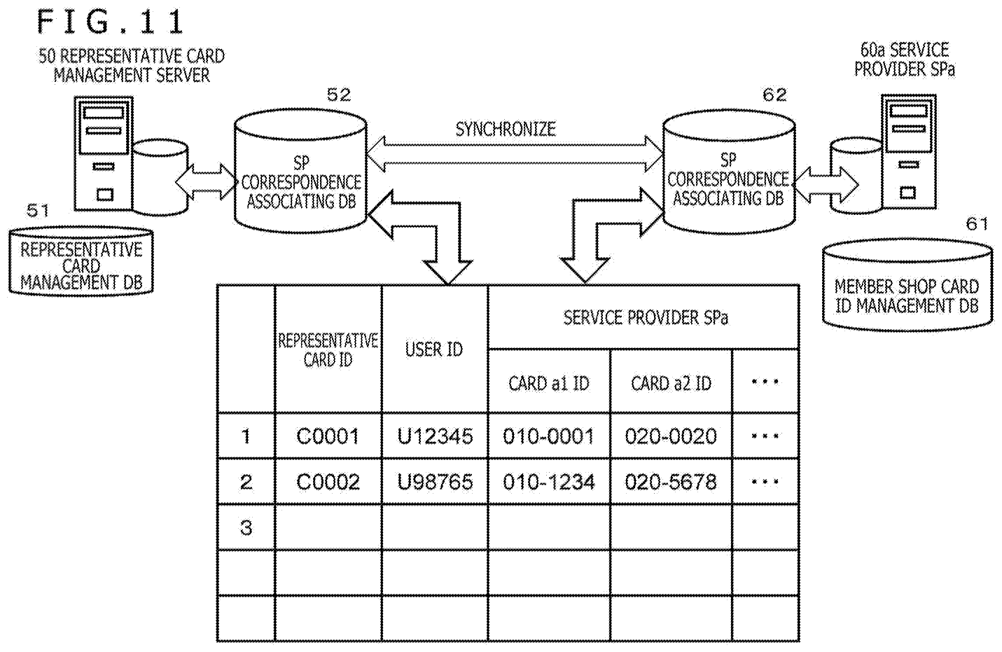

In step S34, the representative card management server 50 notified by the user Ua, 80a of the member shop card information registered in the representative card or the representative card application executes a database update process for updating the representative card management DB 51 described above with reference to FIG. 6 and a service provider (SP) correspondence associating DB 52 depicted in FIG. 11.

Specifically, the representative card management server 50 adds an ID of an actual card newly registered in entries of the representative card whose information has been updated to the representative card management DB 51 described with reference to FIG. 6, and registers this ID in the representative card management DB 51. For example, in a case of reception of notification that registration completion of a member shop card (card a1 ID=010-0001) from the owner (user ID=U12345) of the representative card in the initial entry (representative card ID=C0001) of the representative card management DB 51 depicted in FIG. 6, the representative card management server 50 executes a process for adding the registered member shop card information (card a1 ID=010-0001) in the entry 1 depicted in FIG. 6.

Note that the representative card management server 50 also executes a database update process for updating the service provider (SP) correspondence associating DB 52 depicted in FIG. 11 in step S34.

The service provider (SP) correspondence associating DB 52 includes part of data contained in the representative card management DB 51 depicted in FIG. 6. Specifically, the service provider (SP) correspondence associating DB 52 is a database which manages correspondence data (associating data) between the representative card for each specific service provider and an actual card.

The service provider (SP) correspondence associating DB 52 depicted in FIG. 11 is a database where respective data of:

a representative card ID;

a user ID; and

an ID of a card managed by the service provider in association with each other similarly to the representative card management DB 51 depicted in FIG. 6.

Note that a database storing data similar to the data of the service provider (SP) correspondence associating DB 52 (service provider (SP) correspondence associating DB 62) retains a service provider (SP) as well. These two databases each execute a synchronization process for matching stored data in one of the databases with stored data in the other database as necessary.

### (Steps S35 to S36)

Processing in steps S35 to S36 corresponds to the database synchronization process described above.

In a case where the database update process for updating the service provider (SP) correspondence associating DB 52 depicted in FIG. 11 in step S34 is executed, the representative card management server 50 notifies the service provider SPa, 60a of update information associated with the service provider (SP) correspondence associating DB 52 in step S35.

In step S36, the service provider SPa, 60a having received this update information executes an update process for updating the service provider (SP) correspondence associating DB 62 owned by the service provider SPa, 60a, i.e., the service provider (SP) correspondence associating DB 62 depicted in FIG. 11.

Specifically, the service provider SPa, 60a executes a process (synchronization process) for matching contents of data stored in the service provider (SP) correspondence associating DB 62 owned by the service provider SPa, 60a with data stored in the service provider (SP) correspondence associating DB 52 owned by the representative card management server 50.

By these processes described above, the representative card or the representative card application owned by the user Ua, 80a is made available as a card managed by the service provider SPa, 60a.

The process following the sequence depicted in FIG. 9 is executed by each service provider which manages a member shop card desired to be registered by the user in the representative card or the representative card application.

Card information available in a shop managed by one or more service providers is registered in the representative card or the representative card application owned by the user Ua, 80a according to the sequence depicted in FIG. 9, and each of the representative card and the representative card application is made available as a card.

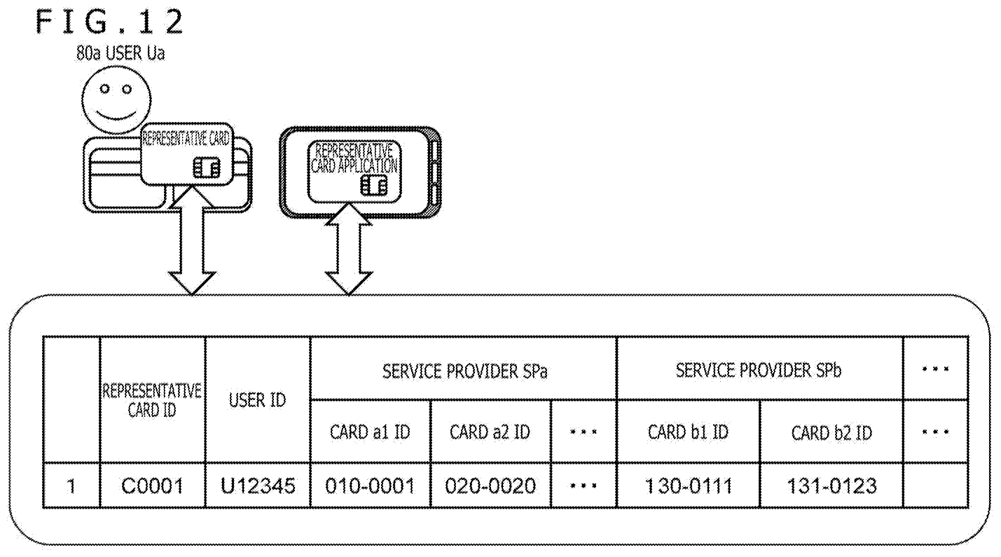

An example of data registered in a memory of the representative card, or a memory supporting the representative card application (a memory in the smartphone) will be described with reference to FIG. 12.

As depicted in FIG. 12, following items of data are stored in the memory of the representative card or the memory supporting the representative card application (the memory is the smartphone), for example.

(a) representative card ID

(b) user ID

(c) card information available is a shop managed by respective service providers

The user can use this representative card as a card recorded in (c) described above.

Subsequently described will be a use process sequence for using the representative card or the representative card application where card information available in a shop managed by one or more service providers is registered.

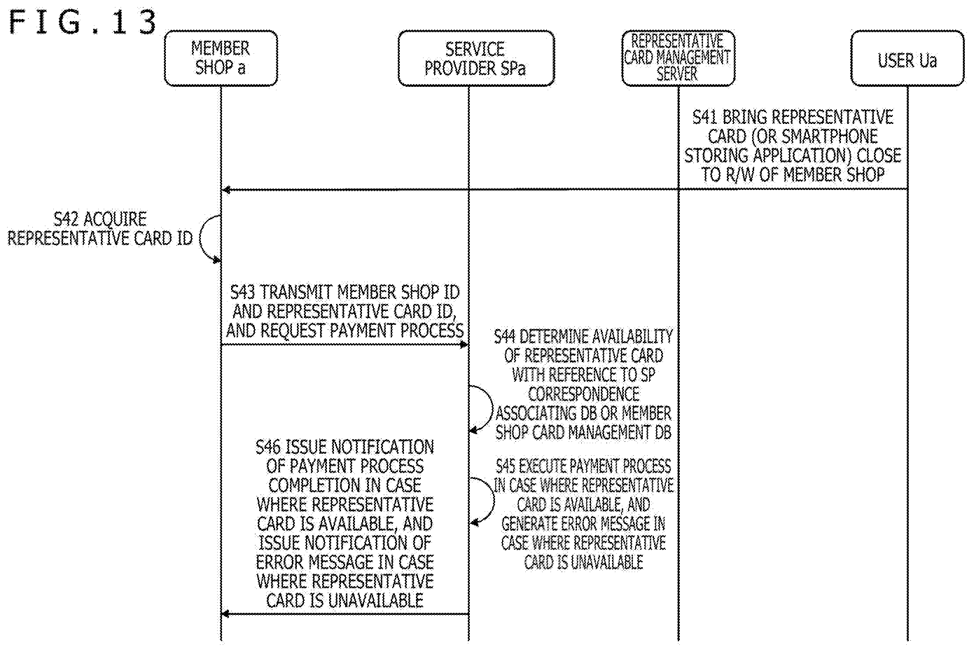

FIG. 13 is a sequence diagram explaining the use process sequence for using the representative card or the representative card application. The member shop a, 70a, the service provider SPa, 60a, the representative card management server 50, and the user Ua, 80a are presented in this order from the left.

Processing performed in respective steps will be sequentially described.

### (Step S41)

In step S41, the user Ua, 80a who owns the representative card or the representative card application where card information available in a shop managed by one or more service providers is registered initially brings the representative card, or the smartphone where the representative card application has been installed close to a reader/writer (R/W) of the member shop a, 70a which is a shop to be used.

### (Step S42)

In step S42, the reader/writer (R/W) of the member shop a, 70a reads a representative card ID from the representative card, or the smartphone where the representative card application has been installed.

### (Step S43)

In step S43, the reader/writer (R/W) (or R/W controller) of the member shop a, 70a transmits, to the service provider SPa, 60a executing the payment process, a payment process request including other necessary information, such as a member shop ID, payment amount information, and date and time information, as well as the representative card, or the representative card ID read from the smartphone.

### (Step S44)

In step S44, the service provider SPa, 60a having received the payment process request from the reader/writer (R/W) (or R/W controller) of the member shop a, 70a determines whether or not payment is enabled with reference to the database retained by the service provider SPa, 60a.

Specifically, it is determined whether or not payment is enabled with reference to the service provider (SP) correspondence associating DB 62 retained by the service provider SPa, 60a, or data registered in the member shop card management DB 61.

In a case where the representative card ID included in the payment process request from the reader/writer (R/W) of the member shop a, 70a, and the card information associated with the member shop a, 70a are registered in the service provider (SP) correspondence associating DB 62 or the member shop card management DB 61 as correspondence data, it is determined that the payment process is enabled. In a case where the representative card ID and the card information are not registered, it is determined that the payment process is disabled.

### (Step S45)

In step S45, the service provider SPa, 60a executes any one of following processes.

In a case where the payment process is enabled in step S44, the payment process is executed. For example, a money transfer process for transferring a payment amount from a registered bank account of the user to a shop account, or a like process is performed, for example.

On the other hand, in a case where the payment process is disabled in step S44, an error message is generated without executing the payment process.

### (Step S46)

In step S46, the service provider SPa, 60a further executes any one of following processes.

In a case where the payment process is executed in step S-IS on the basis of determination that the payment process is enabled in step S44, a payment process completion notification is issued to the reader/writer (R/W) (or R/W controller) of the member shop a, 70a.

On the other hand, in a case where the payment process is not executed in step S45 on the basis of determination that the payment process is disabled in step S44, notification of an error message is issued to the reader/writer (R/W) (or R/W controller) of the member shop a, 70a.

By these processes described above, the user Ua, 80a is allowed to use the representative card or the representative card application as a card available in the shop managed by the service provider.

### [5. Regarding Embodiment Determining Card Availability by Representative Card Management Server]

The embodiment described with reference to FIGS. 9 to 13 is a processing example where the service provider determines whether or not the representative card or the representative card application is available.

Described hereinafter will be a second embodiment where the representative card management server determines card availability.

According to the second embodiment, only the representative card management server 50 may be required to retain the service provider correspondence associating DB described above with reference to FIG. 11.

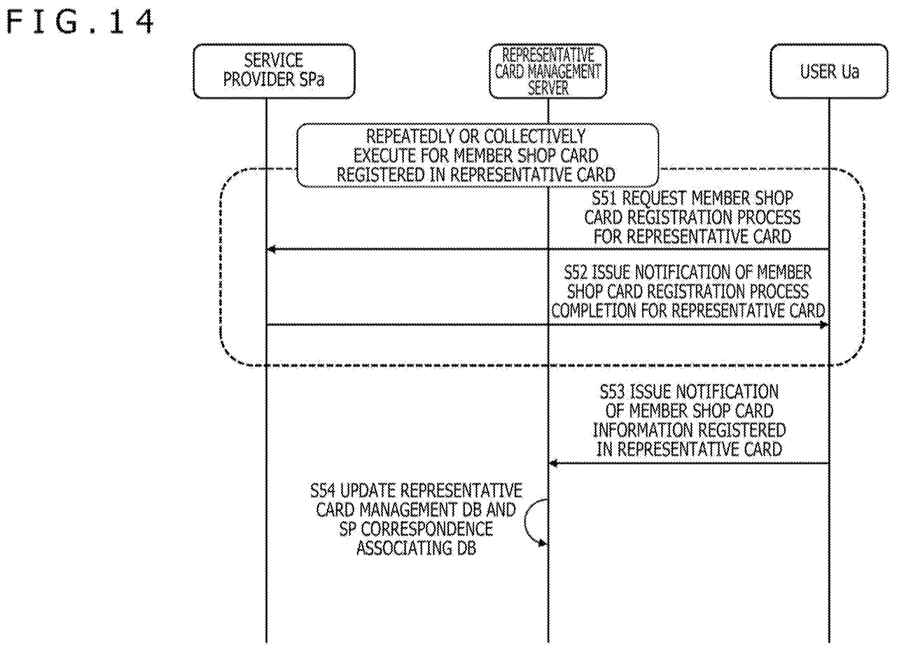

FIG. 14 is a sequence diagram explaining a registration process sequence for registering available actual card information for the representative card or the representative card application acquired by the user in the present embodiment.

FIG. 14 depicts the service provider SPa, 60a, the representative card management server 50, and the user Ua, 80a, in this order from the left.

Processing performed in respective steps will be sequentially described.

### (Steps S51 to S52)

In step S51, the user Ua, 80a having acquired the representative card or the representative card application according to the process sequence depicted in FIG. 7 or 8 initially issues a member shop card registration request to the service provider SPa, 60a to register a member shop card in the representative card or the representative card application owned by the user Ua, 80a.

In step S52, the service provider SPa, 60a having received the registration request from the user Ua, 80a configures such a setting as to make the representative card or the representative card application owned by the user Ua, 80a available as a card of a member shop to which the request has been issued, i.e., executes a member shop card registration process, and notifies the user Ua, 80a of registration completion.

These processes are similar to the processes performed in steps S31 to 832 described above with reference to FIG. 9.

For example, the service provider SPa, 60a has the member shop card management DB 61 having a data configuration depicted in FIG. 10.

The service provider SPa, 60a performs a process for adding one entry of issued card ID and user ID to entries corresponding to the member shop to which the registration request has been issued from the user Ua, 80a, and then registering the added entry in the member shop card management DB 61.

### (Step S53)

In step S53, the user Ua, 80a having received the registration completion notification from the service provider SPa, 60a in step S52 notifies the representative card management server 50 of member shop card information registered in the representative card or the representative card application.

### (Step S54)

In step S54, the representative card management server 50 notified by the user Ua, 80a of the member shop card information registered in the representative card or The representative card application executes a database update process for the representative card management DB 51 described above with reference to FIG. 6, and the service provider (SP) correspondence associating DB 52.

Specifically, the representative card management server 50 adds an ID of an actual card newly registered in entries of the representative card whose information has been updated to the representative card management DB 51 described with reference to FIG. 6, and registers this ID in the representative card management DB 51.

A similar database update process is also executed for the service provider (SP) correspondence associating DB 52.

Note that the service provider (SP) correspondence associating DB 52 of the present embodiment is retained only by the representative card management server 50, and not by the service provider.

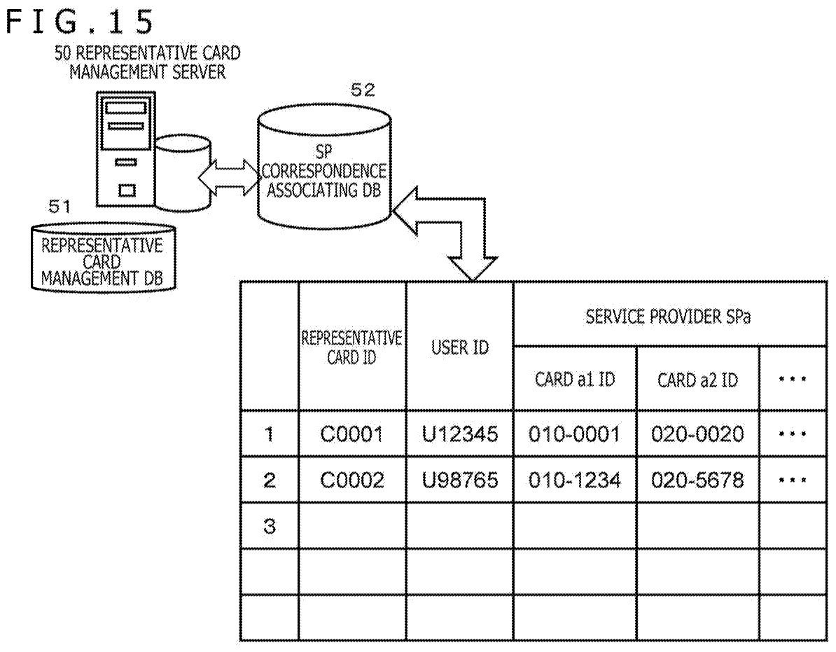

As depicted in FIG. 15, the service provider (SP) correspondence associating DB 52 is a database where respective data of:

a representative card ID;

a user ID; and

an ID of a card managed by the service provider in association with each other.

In step S54, the representative card management server 50 also executes a database update process for the service provider (SP) correspondence associating DR 52 depicted in FIG. 15.

By these processes described above, the representative card or the representative card application owned by the user Ua, 80a is made available as a card managed by the service provider SPa, 60a.

While the registration process is required to be executed for each service provider in the sequence described above with reference to FIG. 9, the registration process in the sequence depicted in FIG. 14 can be collectively executed for a plurality of member shops managed by a plurality of different member shops.

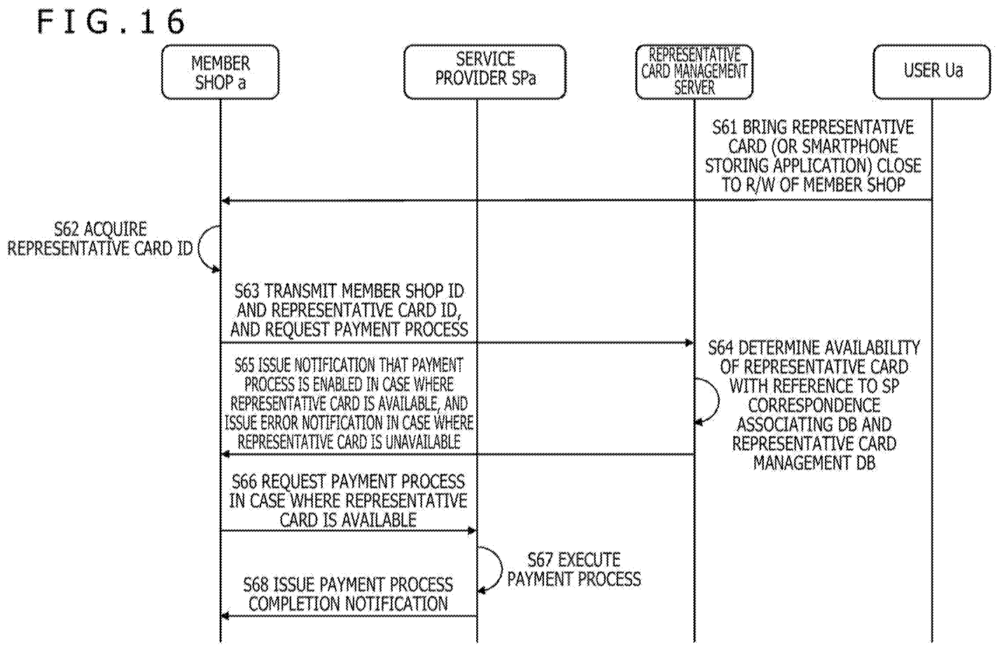

FIG. 16 is a sequence diagram explaining a use process sequence for using the representative card or the representative card application. The member shop a, 70a, the service provider SPa, 60a, the representative card management server 50, and the user Ua, 80a are presented in this order from the left.

Processing performed in respective steps will be sequentially described.

### (Step S61)

In step S61, the user Ua, 80a who owns the representative card or the representative card application where card information available in a shop managed by one or more service providers is registered initially brings the representative card, or the smartphone where the representative card application has been installed close to a reader/writer (R/W) of the member shop a, 70a which is a shop to be used.

### (Step S62)

In step S62, the reader/writer (R/W) of the member shop a, 70a reads a representative card ID from the representative card, or the smartphone where the representative card application has been installed.

### (Step S63)

In step S63, the reader/writer (R/W) (or R/W controller) of the member shop a, 70a transmits, to the representative card management server 50 determining whether or not the payment process is enabled, a payment process request including other necessary information, such as a member shop ID, payment amount information, and date and time information, as well as the representative card, or the representative card ID read from the smartphone.

### (Step S64)

In step S64, the representative card management server 50 having received the request for determining whether or not the payment process is enabled from the reader/writer (R/W) (or R/W controller) of the member shop a, 70a determines whether or not payment is enabled with reference to the database retained by the representative card management server 50.

Specifically, it is determined whether or not payment is enabled with reference to the service provider (SP) correspondence associating DB 52 retained by the representative card management server 50, or data registered in the representative card management DB 51.

In a case where the representative card ID included in the payment process request from the reader/writer (R/W) of the member shop a, 70a, and the card information associated with the member shop a, 70a are registered in the service provider (SP) correspondence associating DB 52 or the representative card management DB 51 as correspondence data, it is determined that the payment process is enabled. In a case where the representative card ID and the card information are not registered, it is determined that the payment process is disabled.

### (Step 865)

In step S65, the representative card management server 50 executes any one of following processes.

In a case where the payment process is determined to be enabled in step S64, a payment process enabled notification process is executed for the reader/writer (R/W) (or R/W controller) of the member shop a, 70a.

On the other hand, in a case where the payment process is determined to be disabled in step S64, an error notification is issued to the reader/writer (R/W) (or R/W controller) of the member shop a, 70a.

### (Step S66)

In step S66, the reader/writer (R/W) (or R/W controller) of the member shop a, 70a executes any one of following processes.

In a case of reception of the payment process enabled notification from the representative card management server 50 in step S65, a payment process request is transmitted to the service provider SPa, 60a.

On the other hand, in a case of reception of an error notification (payment process disabled notification) from the representative card management server 50 in step S65, an error message is output.

### (Step S67)

In step S67, the service provider SPa, 60a having received the payment process request from the reader/writer (R/W) (or R/W controller) of the member shop a, 70a in step S66 executes the payment process. For example, a money transfer process for transferring a payment amount from a registered bank account of the user to a shop account, or a like process is performed, for example.

### (Step S68)

In step S68, the service provider SPa, 60a notifies the reader/writer (R/W) (or R/W controller) of the member shop a, 70a of payment process completion.

By these processes described above, the user Ua, 80a is allowed to use the representative card or the representative card application as a card available in the shop managed by the service provider.

### [6. Regarding Other Embodiments]

Other embodiments to which the configuration and the processes of the present disclosure are applicable will be subsequently described.

Following embodiments will be described.

(1) Regarding embodiment using code information as representative card

(2) Regarding embodiment setting use priority in shop

### (6-1. Regarding Embodiment Using Code Information as Representative Card)

An embodiment which uses code information as a representative card will be initially described.

According to the embodiment described above, as explained above with reference to FIG. 3, the one representative card 21, or the one representative card application 31 installed in a smartphone 30 is available as various different types of cards or card applications.

The configuration available as the representative card is not limited to the one representative card 21, or the one representative card application 31 installed in a smartphone 30.

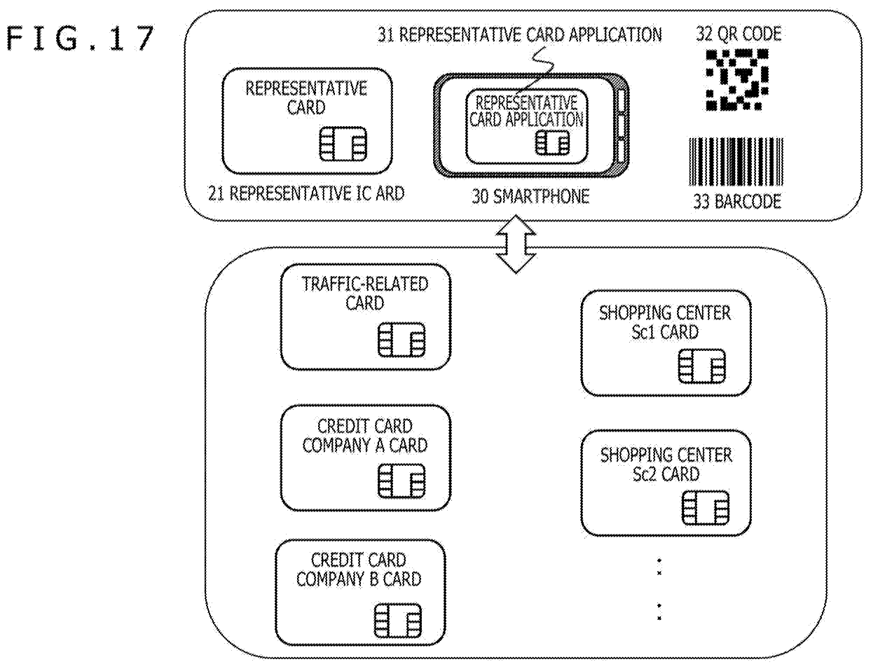

For example, as depicted in FIG. 17, code data such as a QR code (registered trademark) 32 and a barcode 33 is also available as data having a function similar to the function of the representative card.

### (6-2. Regarding Embodiment Setting Use Priority in Shop)

An embodiment which sets use priority in a shop will be subsequently described.

A large number of card information available in various shops are registered in the representative card to allow use of the representative card as a card for these registered items.

It is assumed that the representative card includes registration of a large number of card information available in one shop.

In this case, the user is required to select which one of the registered cards to be used, and therefore may feel this process inconvenient.

The embodiment described hereinafter has a configuration for eliminating this inconvenience.

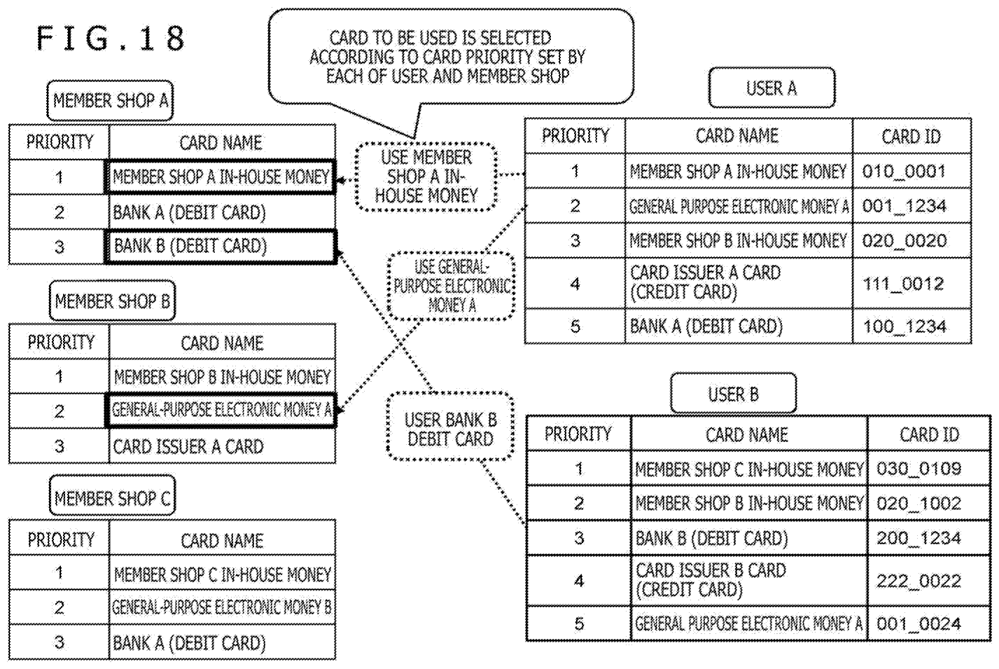

The present embodiment will be described with reference to FIG. 18.

As depicted in FIG. 18, the present embodiment is configured to set priority beforehand for the representative card or the representative card application owned by the user, and record priority information in a memory of the representative card or a memory of a user device such as a smartphone in which the representative card application has been installed, and further register use card priority information is a memory in the R/W (or R/W controller) in each of member shops.

For example, in a case of payment using the representative card in a certain shop, the user selects a card to be used from cards available in the corresponding shop according to priority associated with the representative card or the representative card application of the user.

This use card selection process is automatically executed by the representative card or a control unit of the smartphone. Accordingly, the user is not required to perform a selection process.

Note that also adoptable for this use card selection process is such a configuration which selects the card to be used according to not the priority corresponding to the representative card on the user side, but priority on the shop side.

Alternatively, also adoptable is such a configuration which acquires both the priority corresponding to the representative card on the user side and the priority on the shop side, and determines a card to be used in an integrated manner.

Note that also adoptable is such a configuration which automatically updates the priority corresponding to the representative card on the user side according to a point interest rate, a use rate, or the like, for example.

The representative card or the control unit of the smartphone executes a process for changing priority data stored in the memory according' to the use rate or the point interest rate.

Moreover, adoptable is such a configuration which changes the priority on the member shop side for each representative card, i.e., for each user. Furthermore, adoptable is such a configuration which changes the priority on the basis of a proposal such as campaign information given from a payment service provider or the like.

The payment service provider can also notify the user of information such as a bonus point and an advantage during use. The user can also change the priority on the basis of this information.

Moreover, the payment service provider can also notify the member shop of campaign information or the like, such as a discount of a fee. The member shop can also change the priority on the basis of this information.

### [7. Regarding Available Service Presentation Process Configuration Based on User Behavior History]

An available service presentation process configuration based on a user behavior history will be subsequently described.

As described with reference to FIG. 18, the representative card or the representative card application includes registration of a large number of card information available in one shop.

In this case, a card to be used is selectable on the basis of such priority information as described with reference to FIG. 18.

An embodiment described below is an embodiment which presents information associated with an available card on the basis of user behavior history information as well.

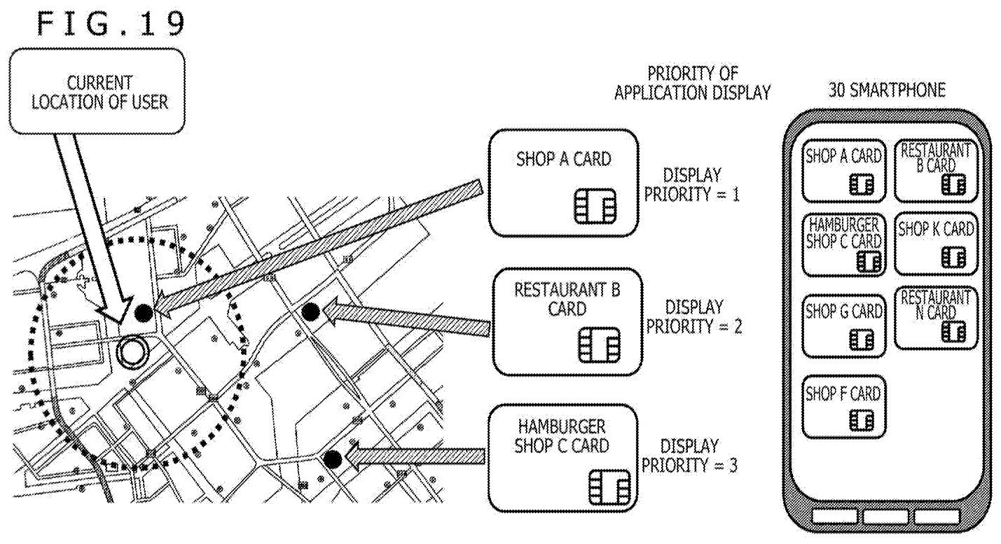

This embodiment will be described with reference to FIG. 19.

The smartphone 30 depicted in FIG. 19 is in a state of display of a list of cards registered in the representative card application.

A current location of the user is detected here using a location detection application of the smartphone 30. Suppose that a double circle indicated on a map in a left part of FIG. 19 represents the current location of the user.

The representative card application in the smartphone 30 searches a shop where a card registered in the representative card is available in a neighborhood within a predetermined radius around the current location of the user.

Moreover, the representative card application displays card list data on the smartphone, as data where card information associated with cards available in the shop obtained by the search is listed in a high order.

Specifically, the control unit of the user device such as a smartphone executes a process for changing priority data stored in the memory according to a user Location or a user behavior history, and further executes a process for determining a display order of registration card information to be displayed on a display unit according to the priority data stored in the memory, or like processes.

As described above, card information associated with cards currently available for the user is displayed in a high order. Accordingly, the user can select and use a card in a near shop without a difficulty in making a decision of card selection.

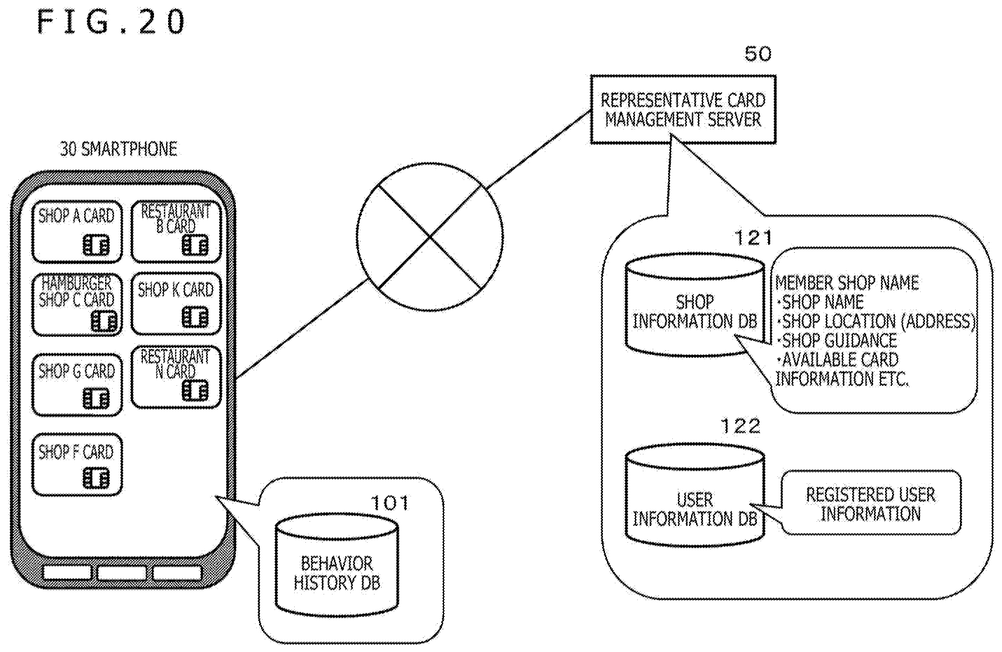

FIG. 20 is a system configuration example for achieving this process.

The smartphone 30 is configured to be communicable with the representative card management server 50 via a network.

A representative card management application in the smartphone 30 acquires location information and behavior history information associated with the user, and stores the acquired information in a behavior history GB 101, and also transmits the acquired information to the representative card management server 50.

The representative card management server 50 includes a shop information DB 121 and a user information DB 122.

A member shop name, a shop location, shop guidance information, available card information, and others are recorded in the shop information DB 121.

A user information of the user having the representative card, and also current location information, behavior history information, and the like received from the smartphone 30 are recorded in the user information DB 122.

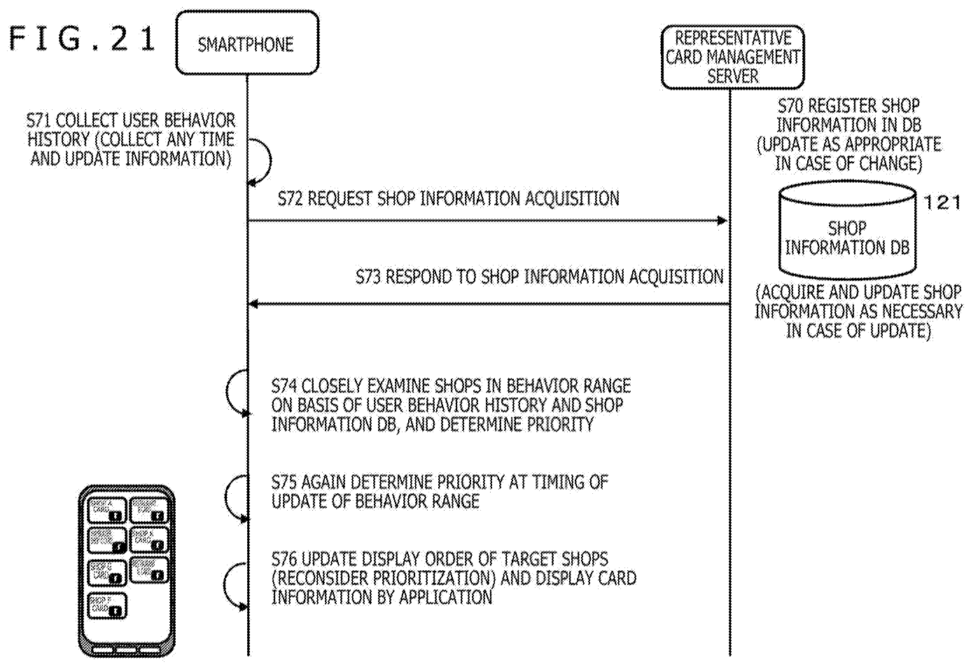

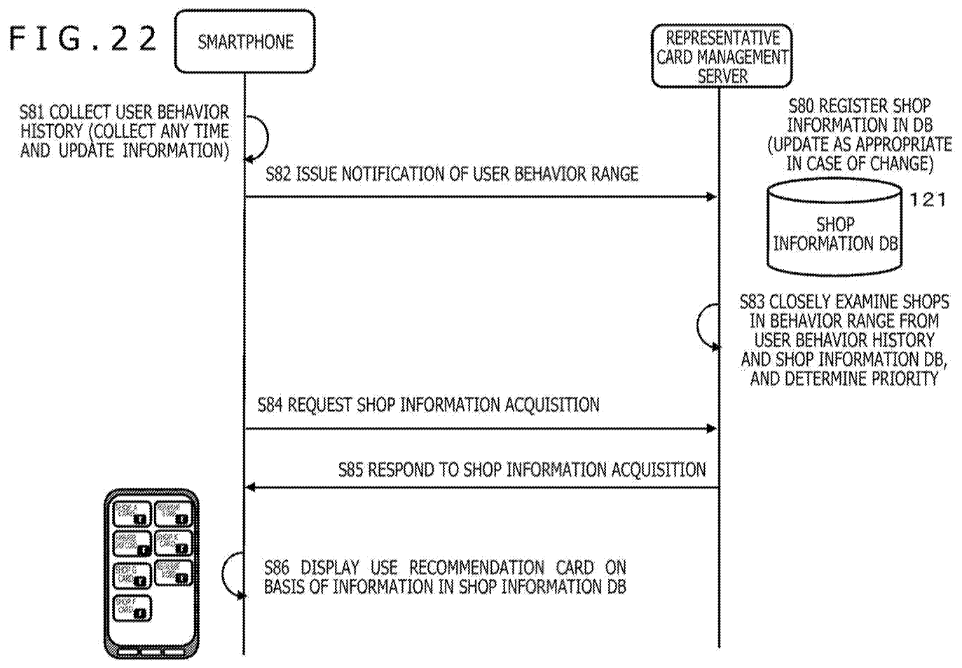

A process sequence executed by this system configuration depicted in FIG. 20 will be described with reference to FIGS. 21 and 22.

FIG. 21 is a smartphone-driven process sequence, while FIG. 22 is a server-driven. process sequence.

The smartphone-driven process sequence will be initially described with reference to a sequence diagram presented in FIG. 21.

### (Step S70)

Processing in step S70 is preprocessing executed by the representative card management server 50.

The representative card management server 50 acquires shop information, i.e., shop information to be stored in the shop information DB 121 described with reference to FIG. 20 from respective shops, and registers the acquired shop information in the shop information DB 121.

In a case where a new shop is opened, for example, the DB having acquired the shop information is sequentially updated.

After this preprocessing, processing in step S7i and following steps will be executed.

### (Step S71)

Initially, the smartphone 30 collects behavior history information containing location information associated with the user corresponding to the smartphone owner.

### (Step S72)

Subsequently, the smartphone 30 transmits a shop information acquisition request to the representative card management server 50.

For example, the smartphone 30 transmits the shop information acquisition request according to the current location information or the like.

### (Step S73)

In step S73, the representative card management server 50 having received the shop information acquisition request from the smartphone 30 searches a shop near the current location of the smartphone 30 (current location of the user) from the shop information DB 121, and transmits shop information associated with the shop obtained as a search result to the smartphone 30.

### (Steps S74 to 76)

The smartphone 30 having received the shop information from the representative card management server 50 executes following processing.

In step S74, the smartphone 30 closely examines shops present within a behavior range on the basis of a behavior history of the user and the shop information, and determines priority. For example, the smartphone 30 determines priority under a rule specified beforehand, such as priority according to a distance from the current location of the user, and priority according to use frequency.

Note that the smartphone 30 again determines priority at update timing in step S75 in a case of update of the current location or the behavior range of the user.

In subsequent step S76, the smartphone 30 updates a display order of shops for which priority has been set such that the display order follows the priority, and displays information associated with available cards and the shops.

This processing allows the user to rapidly find a card-available shop located near the current location, and also rapidly recognize cards available in this shop.

The server-driven process sequence will be subsequently described with reference to a sequence diagram depicted in FIG. 22.

### (Step S80)

Processing in step S80 is preprocessing executed by the representative card management server 50.

The representative card management server 50 acquires shop information., i.e., shop information to be stored in the shop information DB 121 described with reference to FIG. 20 from respective shops, and registers the acquired shop information is the shop information DB 121.

In a case where a new shop is opened, for example, the DB having acquired the shop information is sequentially updated.

After this preprocessing, processing in step S81 and following steps will be executed.

### (Step S81)

Initially, the smartphone 30 collects behavior history information containing location information associated with the user corresponding to the smartphone owner.

### (Step S82)

In subsequent step S82, the smartphone 30 transmits behavior history information containing the user location information acquired in step S81 to the representative card management server 50.

### (Step S83)

In subsequent step S83, the representative card management server 50 executes a search process for searching the shop information DB 121 on the basis of the behavior history information containing the user location information and received from the smartphone 30, extracts a shop near the current location of the smartphone 30 (the current location of the user), and further determines priority. For example, the smartphone 30 determines priority under a rule specified beforehand, such as priority according to a distance from the current location of the user, and priority according to use frequency.

### (Step S84)

In subsequent step S84, the smartphone 30 transmits a shop information acquisition request to the representative card management server 50.

For example, the smartphone 30 transmits the shop information acquisition request together with the current location information or the like.

### (Step S85)

In step S85, the representative card management server 50 having received the shop information acquisition request from the smartphone 30 transmits, to the smartphone 30, the shop information for which priority has been set, i.e., the shop information for which priority of the shops near the current location of the smartphone 30 (the current location of the user) has been set.

### (Step S86)

In step S86, the smartphone 30 having received the shop information from the representative card management server 50 sets a display order of the shops such that the display order follows the priority, and displays information associated with available cards and the shops.

This processing allows the user to rapidly find a card-available shop located near the current location, and also rapidly recognize cards available in this shop.

[8. Regarding Hardware Configuration Example of information Processing Apparatus]

A configuration example of an information processing apparatus of the present disclosure will be subsequently described.

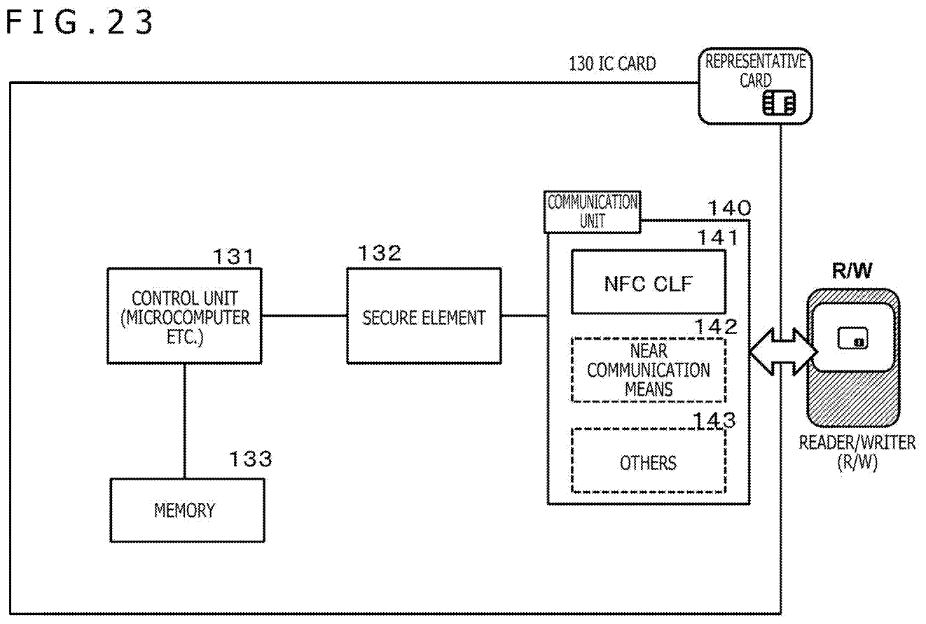

FIG. 23 is a diagram depicting a configuration example of an IC card constituting the representative card.

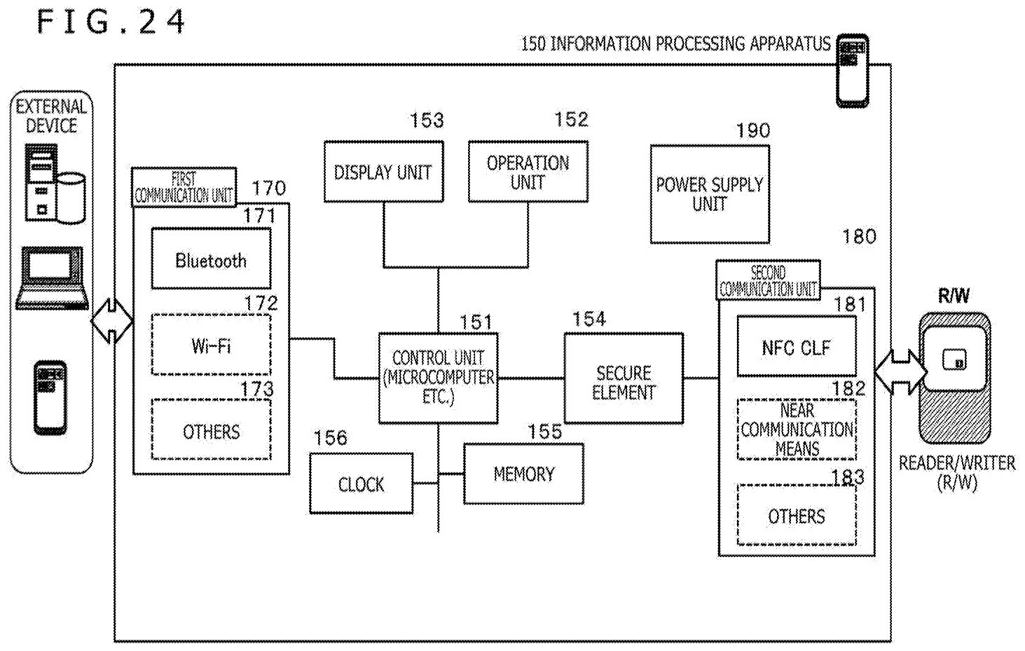

FIG. 24 is a diagram depicting a configuration example of a smartphone in which the representative card application is allowed to be installed.

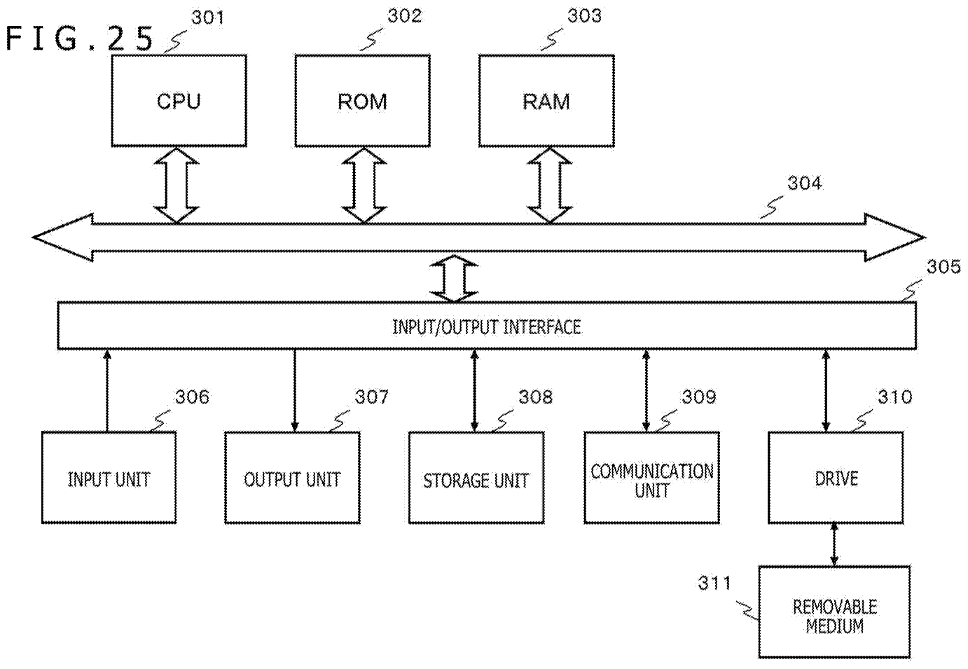

FIG. 25 is a diagram depicting a hardware configuration example of a representative card management server, a service provider server, and an R/W controller of a member shop.

Respective configurations of these will be sequentially explained.

A configuration example of an IC card 130 constituting the representative card will be initially described with reference to FIG. 23.

As depicted in FIG. 23, the IC card 130 includes a control unit (e.g., microcomputer) 131, a secure element 132, a memory 133, and a communication unit 140.

For example, the communication unit 140 includes at least any one of an NFC-CLF 141, near communication means 142, and other communication units 143.

Note that code data such as a QR code (registered trademark) and a barcode is also available as data having a function similar to the function of the representative card or the registration card as described above with reference to FIG. 17. The IC card 130 may have a configuration of a card where the code information described here is recorded.

The control unit (e.g., microcomputer) 131 controls processes executed by the IC card 130. Specifically, for example, the control unit 131 controls communication with the reader/writer (R/W), performs an authentication process, and others. Note that control programs and the like executed by the control unit (e.g., microcomputer) 131 are stored in the memory 133.

The secure element 132 is an IC chip having a configuration of an element including a secure memory and a memory control unit.

As described above, the memory 133 is a memory where control programs executed by a control unit 151, various types of ID information, and others are recorded.

A configuration example of an information processing apparatus 150 in which the representative card application is allowed to be installed, such as a smartphone, will be subsequently described with reference to FIG. 24.

As depicted in FIG. 24, the information processing apparatus 150 such as a smartphone includes the control unit (e.g., microcomputer) 151, an operation unit 152, a display unit 153, a secure element 154, a memory 155, a clock 156, a first communication unit 170, a second communication unit 180, and a power supply unit 190.

The first communication unit 170 includes a Bluetooth (registered trademark) communication unit 171, a Wi-Fi communication unit 172, and other communication units 173. The second communication unit 160 includes an NFC-CLF 181, near communication means 182, and other communication units 183.

The control unit (e.g., microcomputer) 151 controls processes executed by the information processing apparatus 150. Note that control programs, applications, and the like executed by the control unit (e.g., microcomputer) 151 are stored in the memory 155.

The operation unit 152 is an operation unit operable by the user, and includes various types of switches, a touch panel on the display unit 153, and others. The user is allowed to input various types of information via the operation unit 152.

The display unit 153 is a display unit such as a liquid crystal display, for example, and is used for display of information associated with execution of various types of applications.

The secure element 154 is an IC chip having a configuration of an element including a secure memory and a memory control unit. The secure memory in the secure element 154 stores an IC card function providing application and the like.

As described above, the memory 155 is a memory in which control programs executed by the control unit 151, applications, ID information and others are recorded.

The clock 156 is time information, and outputs clock information to respective processing units.

The first communication unit 170 includes the Bluetooth (registered trademark) communication unit 171, the Wi-Fi communication unit 172, and the other communication units 173, and is used for communication with external devices such as a server, a PC, a smartphone, and a wearable device, for example. The second communication unit 180 includes the NFC-CLF 181, the near communication means 182, and the other communication units 183, and performs processing for communication with the reader/writer 21, for example.

The NFC-CLF 181 is an NFC (Near Field Communication)-CLF (Contact less Front End), and is a type of IC chip for near field communication.

Note that code data such as a QR code (registered trademark) and a barcode is also available as data having function similar to the function of the representative card or the registration card as described above with reference to FIG. 17. The information processing apparatus 150 may be configured to have a function of storing the code information described here in the memory, and displaying the code information on the display unit.

A hardware configuration example of a representative card management server, a service provider server, and an R/W controller of a member shop will be subsequently described with reference to FIG. 25.

The configuration depicted in FIG. 25 will be described.

A CPU (Central Processing Unit) 301 functions as a control unit or a data processing unit which executes various types of processing under programs stored in a RUM (Read Only Memory) 302 or a storage unit 308. For example, the CPU 301 executes processes following the sequences described in the above embodiments. A RAM (Random Access Memory) 303 stores programs executed by the CPU 301, data, and others. The CPU 301, the ROM 302, and the RAM 303 described here are connected to one another via a burs 304.

The CPU 301 is connected to an input/output interface 305 via the bus 304, while an input unit 306 including various types of switches, a keyboard, a mouse, a microphone, and others, and an output unit 307 including a display, a speaker, and the like are connected to the input/output interface 305. The CPU 301 executes various types of processing in response to a command input through the input unit 306, and outputs a processing result to the output unit 307, for example.

The storage unit 308 connected to the input/output interface 305 includes a flash memory, a hard disk, or the like, for example, and stores programs executed by the CPU 301, and various types of data. A communication unit 309 functions as a transmission and reception unit for Wi-Fi communication, Bluetooth (registered trademark) (RI) communication, and other data communication via the Internet, a local area network, or the like, and communicates with external devices.

A drive 310 connected to the input/output interface 305 drives a removable medium 311 such as a magnetic disk, an optical disk, a magneto-optical disk, and a semiconductor memory like a memory card or the like, and executes data recording or data reading.

### [9. Summary of Configuration of Present Disclosure]

Embodiments of the present disclosure have been described above in detail with reference to the specific embodiments. However, it is obvious that those skilled in the art can make corrections or substitutions for the embodiments without departing from the scope of the subject matters of the present disclosure. Accordingly, the present invention disclosed herein only in the form of an example should not be interpreted in any limited manner. The claims should be taken into consideration for determining the subject matters of the present disclosure.

Note that the technology disclosed in the present specification may have following configurations.
(1)

An information processing apparatus including:

a memory that stores a representative card ID that is an identifier of a representative card; and

a control unit that executes a use process for using a registration card registered in association with the representative card, in which

the use process for using the registration card is executed under a condition that registration card information associated with the registration card is recorded in a database in association with the representative card.
(2)

The information processing apparatus according to (1), including

a communication unit that communicates with a reader/writer, in which

the control unit is a communication unit that executes communication with the reader/writer executing the use process for using the registration card registered in association with the representative card through communication with the reader/writer, and an identifier of the representative card.
(3)

The information processing apparatus according to (1) or (2), is which

the database includes a database managed by a server.
(4)

The information processing apparatus according to any one of (1) to (3), in which

the database includes a database managed by a representative card management server that executes a representative card management process, or a service provider that executes a management process for managing the registration card.
(5)

The information processing apparatus according to any one of (1) to (4), in which

the control unit associates a new registration card with the representative card through communication with a representative card management server that executes a management process for managing the representative card.
(6)

The information processing apparatus according to any one of (1) to (5), in which

the database includes a database that includes data where the representative card ID, a user ID, and an ID of the registration card registered in association with the representative card are recorded in association with each other.
(7)

The information processing apparatus according to any one of (1) to (6), in which

the memory stores priority data that specifies use priority of registration cards registered in association with the representative card, and

the control unit determines a registration card to be used according to the priority data.
(8)

The information processing apparatus according to (7), in which

the control unit executes a process for sequentially updating the priority data stored in the memory.
(9)

The information processing apparatus according to (7) or (8), in which

the control unit executes a process for changing the priority data stored in the memory according to a use rate or a point interest rate.
(10)

The information processing apparatus according to any one of to (9), in which

the control unit executes a process for changing the priority data stored in the memory according to a user location or a user behavior history.
(11)

The information processing apparatus according to any one of (1) to (10), in which

the control unit determines a card to be used on the basis of card priority data managed by a shop to be used.
(12)

The information processing apparatus according to any one of (1) to (11), in which
the control unit determines an order of display of registration card information to be displayed on a display unit according to priority data stored in the memory.
(13)

An information processing system including:

a user device;

a server; and

a shop side device, in which

the user device causes the shop side device to read a representative card ID stored in a memory of the user device,

the shop side device transmits the representative card ID to the server, and

the server determines card availability of whether or not the representative card ID is a representative card ID available for the shop side device, and executes a payment process under a condition that the card availability has been determined.
(14)

The information processing system according to (13), in which

the shop side device includes a reader/writer,

the user device communicates with the reader/writer, and transmits the representative card ID stored in the memory of the user device,

the reader/writer transmits the representative card ID to the server, and

the server determines card availability of whether or not the representative card ID is a representative card ID available for the reader/writer, and executes a payment process under a condition that the card availability has been determined.
(15)

The data processing system according to (13) or (14), is which

the server executes a determination process for determining the card availability with reference to a database where the representative card ID and a registration card ID registered is association with the representative card are recorded in association with each other.
(16)

The data processing system according to any one of (13) to (15), in which

the user device transmits, to the server, a request for associating a new registration card with the representative card, and

the server records correspondence data between the representative card ID and an ID of the new registration card in a database in response to the request issued from the user device.
(17)

An information processing method executed by an information processing apparatus, in which

the information processing apparatus includes a memory that stores a representative card ID that is an identifier of a representative card, and

a control unit of the information processing apparatus executes a use process for using a registration card registered in association with the representative card under a condition that registration card information associated with the registration card is recorded in a database in association with the representative card.
(18)

An information processing method executed by as information processing system that includes a user device, a server, and a shop side device, in which

the user device causes the shop side device to read a representative card ID stored is a memory of the user device,

the shop side device transmits the representative card ID to the server, and

the server determines card availability of whether or not the representative card ID is a representative card ID available for the shop side device, and executes a payment process under a condition that the card availability has been determined.
(19)

A program causing an information processing apparatus to execute information processing, in which

the information processing apparatus includes a memory that stores a representative card ID that is an identifier of a representative card, and

the program causes a control unit of the information processing apparatus to execute a use process for using a registration card registered in association with the representative card under a condition that registration card information associated with the registration card is recorded in a database in association with the representative card.

Moreover, a series of processes described in the specification can be executed by hardware, software, or a composite configuration of both. In a case of execution of the processes by software, a program where process sequences are recorded can be executed after installed in a memory in a computer incorporated in dedicated hardware, or this program can be executed after installed in a general-purpose computer capable of executing various types of processes. For example, the program can be recorded in a recording medium in advance. The program can be installed in a computer from the recording medium, or received via a network such as a LAN (Local Area Network) and the Internet and installed in a built-in recording medium such as a hard disk.

Note that various types of processes described in the specification may be executed not only in time series according to the description, but also may be executed in parallel or individually according to processing performance of an apparatus executing the processes or as necessary. Moreover, the system in the present specification refers to a logical set configuration constituted by a plurality of devices, and is not limited to a type where devices of respective configurations are included in an identical housing.

### INDUSTRIAL APPLICABILITY

As described above, according to an embodiment of the present disclosure, a configuration allowing use of one representative card as various types of cards is achievable.

Specifically, for example, there are provided a memory that stores a representative card ID that is an identifier of a representative card, and a control unit that executes a use process for using a registration card registered in association with the representative card through communication between a reader/writer. The use process for using the registration card is executed under a condition that registration card information associated with the registration card is recorded in a database in association with the representative card. The database is a database managed by a server, and including data where the representative card ID, a user ID, and an ID of the registration card registered in association with the representative card are recorded in association with each other.

This configuration achieves such a configuration allowing use of one representative card as various types of cards.

### REFERENCE SIGNS LIST

10: User

12: Smartphone

21: Representative card

30: Smartphone

31: Representative card application

50: Representative, card management server

51: Representative card management DB

52: SP correspondence associating DB

60: Service provider

61: Member shop card management DB

62: SP correspondence associating DB

70: Member shop

80: User

101: Behavior history DB

121: Shop information DB

122: User information DB

130: IC card.

131: Control unit (e.g., microcomputer)

132: Secure element

133: Memory

140: Communication unit

150: Information processing apparatus

151: Control unit (e.g., microcomputer)

152: Operation unit

153: Display unit

154: Secure element

155: Memory

156: Clock

170: First communication unit

80: Second communication unit

190: Power supply unit

301: CPU

302: ROM

303: RAM

304: Bus

305: Input/outputs interface

306: Input unit

307: Output unit

308: Storage unit

309: Communication unit

310: Drive

311: Removable medium

1. An information processing apparatus comprising:
a memory that stores a representative card ID that is an identifier of a representative card; and
a control unit that executes a use process for using a registration card registered in association with the representative card, wherein
the use process for using the registration card is executed under a condition that registration card information associated with the registration card is recorded is a database in association with the representative card.

2. The information processing apparatus according to claim 1, comprising:
a communication unit that communicates with a reader/writer, wherein
the control unit executes the use process for using the registration card registered in association with the representative card through communication with the reader/writer.

3. The information processing apparatus according to claim 1, wherein
the database includes a database managed by a server.

4. The information processing apparatus according to claim 1, wherein
the database includes a database managed by a representative card management server that executes a representative card management process, or a service provider that executes a management process for managing the registration card.

5. The information processing apparatus according to claim 1, wherein
the control unit associates a new registration card with the representative card through communication with a representative card management server that executes a management process for managing the representative card.

6. The information processing apparatus according to claim 1, wherein
the database includes a database that includes data where the representative card ID, a user ID, and an ID of the registration card registered in association with the representative card are recorded is association with each other.

7. The information processing apparatus according to claim 1, wherein
the memory stores priority data that specifies use priority of registration cards registered in association with the representative card, and
the control unit determines a registration card to be used according to the priority data.

8. The information processing apparatus according to claim 7, wherein
the control unit executes a process for sequentially updating the priority data stored in the memory.

9. The information processing apparatus according to claim 7, wherein
the control unit executes a process for changing the priority data stored in the memory according to a use rate or a point interest rate.

10. The information processing apparatus according to claim 7, wherein
the control unit executes a process for changing the priority data stored in the memory according to a user location or a user behavior history.

11. The information processing apparatus according to claim 1, wherein
the control unit determines a card to be used on a basis of card priority data managed by a shop to be used.

12. The information processing apparatus according to claim 1, wherein
the control unit determines an order of display of registration card information to be displayed on a display unit according to priority data stored is the memory.

13. An information processing system comprising:
a user device;
a server; and
a shop side device, wherein
the user device causes the shop side device to read a representative card ID stored is a memory of the user device,
the shop side device transmits the representative card ID to the server, and
the server determines card availability of whether or not the representative card ID is a representative card ID available for the shop side device, and executes a payment process under a condition that the card availability has been determined.

14. The information processing system according to claim 13, wherein
the shop side device includes a reader/writer,
the user device communicates with the reader/writer, and transmits the representative card ID stored in the memory of the user device,
the reader/writer transmits the representative card ID to the server, and
the server determines card availability of whether or not the representative card ID is a representative card ID available for the reader/writer, and executes a payment process under a condition that the card availability has been determined.

15. The data processing system according to claim 13, wherein
the server executes a determination process for determining the card availability with reference to a database where the representative card ID and a registration card ID registered in association with the representative card are recorded in association with each other.

16. The data processing system according to claim 13, wherein
the user device transmits, to the server, a request for associating a new registration card with the representative card, and
the server records correspondence data between the representative card ID and an ID of the new registration card in a database in response to the request issued from the user device.

17. An information processing method executed by an information processing apparatus, wherein
the information processing apparatus includes a memory that stores a representative card ID that is an identifier of a representative card, and
a control unit of the information processing apparatus executes a use process for using a registration card registered in association with the representative card under a condition that registration card information associated with the registration card is recorded in a database in association with the representative card.

18. An information processing method executed by an information processing system that includes a user device, a server, and a shop side device, wherein
the user device causes the shop side device to read a representative card ID stored in a memory of the user device,
the shop side device transmits the representative card ID to the server, and
the server determines card availability of whether or not the representative card ID is a representative card ID available for the shop side device, and executes a payment process under a condition that the card availability has been determined.

19. A program causing an information processing apparatus to execute information processing, wherein
the information, processing apparatus includes a memory that stores a representative card ID that is an identifier of a representative card, and
the program causes a control unit of the information, processing apparatus to execute a use process for using a registration card registered in association with the representative card under a condition that registration card information associated with the registration card is recorded in a database in association with the representative card.
